(19) United States
(12) Patent Application Publication
(10) Pub. No.: US 2013/0077110 A1
(43) Pub. Date: Mar. 28, 2013

(54) PRINTING SYSTEM AND PRINTING METHOD

(71) Applicant: Kumiko OGINO, Osaka (JP)

(72) Inventor: Kumiko OGINO, Osaka (JP)

(21) Appl. No.: 13/612,923

(22) Filed: Sep. 13, 2012

(30) Foreign Application Priority Data
Sep. 22, 2011 (JP) 2011-207126

(51) Int. Cl. G06K 15/16

(52) U.S. Cl. 358/1.12

(57) ABSTRACT

A multi-function peripheral generates, in the case of executing print processing for inserting paper that separates a first sheet on which printing is performed by a first print job and a second sheet on which printing is performed by a second print job that is executed after the first print job, print data including charging information of the first print job or the second print job, and executes print processing for printing on the inserting paper the generated print data, thereby inserting paper for separating sheets on which printing is performed by different print jobs is not only used as merely inserting paper, but utilized effectively as a business document, so that assortment and shipment preparation of printed sheets are facilitated, while clerical work such as recording of expenses is performed promptly and precisely.

### CROSS-NOTING PARAGRAPH

This non-provisional application claims priority under 35 U.S.C. §119(a) on Patent Application No. 2011-207126 filed in JAPAN on Sep. 22, 2011, the entire contents of which are hereby incorporated herein by reference.

### FIELD OF THE INVENTION

The present invention relates to a printing system and a printing method for executing print processing for inserting paper that separates a first sheet on which printing is performed by a first print job and a second sheet on which printing is performed by a second print job that is executed after the first print job.

### BACKGROUND OF THE INVENTION

A conventional multi-function peripheral is provided with a function of inserting inserting paper for separating a sheet printed by a print job and a sheet printed by a separate print job from the print job.

For example, Japanese Laid-Open Patent Publication No. 2009-146126 discloses a printing system that inserts inserting paper on which characters of “This is the last page” are printed between sheets. Furthermore, Japanese Laid-Open Patent Publication No. 2007-28098 discloses an image forming apparatus that prints on inserting paper information such as a print date, a person who instructed printing, the number of print copies, a print mode, a print site, a degree of importance of a document and the like.

However, in the above-described Japanese Laid-Open Patent Publication No. 2009-146126 and Japanese Laid-Open Patent Publication No. 2007-28098, information printed on the inserting paper does not include useful information for a printing company that undertakes printing work from a client and the information cannot be immediately used for business between the printing company and the client.

In other words, when content printed on the inserting paper includes useful information that can be immediately used in business with the client, it can be not only used as mere inserting paper, but utilized effectively as a business document.

### SUMMARY OF THE INVENTION

The present invention aims to provide a printing system and a printing method that enable to utilize inserting paper separating sheets on which printing is performed by different jobs not merely as inserting paper but as a business document, thus facilitating assortment and shipment preparation of printed sheets, and making it possible to perform clerical work such as recording of expenses promptly and precisely.

An object of the present invention is to provide a printing system for executing print processing for inserting paper that separates a first sheet on which printing is performed by a first print job and a second sheet on which printing is performed by a second print job that is executed after the first print job, comprising: a data generation portion that generates print data including charging information of the first print job or the second print job; and a print processing portion that executes print processing for printing on the inserting paper the print data generated by the data generation portion.

Another object of the present invention is to provide the printing system, wherein the print processing portion executes, after executing the first print job and before executing the second print job, the print processing multiple number of times.

Another object of the present invention is to provide the printing system, wherein the print processing portion executes print processing for printing print data of a document issued for a charged party and print processing for printing print data of a document issued for a charging party.

Another object of the present invention is to provide the printing system, further comprising a processing execution portion that executes processing to output the print data as a file.

Another object of the present invention is to provide a printing method for executing print processing for inserting paper that separates a first sheet on which printing is performed by a first print job and a second sheet on which printing is performed by a second print job that is executed after the first print job, comprising: generating print data including charging information of the first print job or the second print job; and executing print processing for printing on the inserting paper the print data generated at the generating.

### BRIEF DESCRIPTION OF THE DRAWINGS

FIG. 1 is a block diagram showing an example of a printing system according to an embodiment of the present invention;

FIG. 2 is a block diagram showing an example of a configuration of a client apparatus according to the embodiment of the present invention;

FIG. 3A and FIG. 3B are diagrams showing an example of a user interface of a printer driver displayed on the client apparatus;

FIG. 4 is a diagram showing an example of a setting screen of print conditions;

FIG. 5 is a block diagram showing an example of a configuration of a server apparatus according to the embodiment of the present invention;

FIG. 6 is a block diagram showing an example of a configuration of a multi-function peripheral according to the embodiment of the present invention;

FIG. 7 is a diagram showing an example of image data printed by print processing according to the embodiment of the present invention;

FIG. 8 is a diagram showing an example of print control processing performed by a control portion of the multi-function peripheral;

FIG. 9 is a diagram showing another example of the print control processing performed by the control portion of the multi-function peripheral;

FIG. 10 is a diagram showing an ejected state of a sheet after being subjected to the print processing shown in FIG. 9;

FIG. 11 is a diagram showing another example of the print control processing performed by the control portion of the multi-function peripheral;

FIG. 12 is a diagram showing an ejected state of a sheet after the print processing shown in FIG. 11;

FIG. 13 is a flowchart showing an example of processing procedure of the print processing according to the embodiment of the present invention; and

FIG. 14 is a flowchart showing an example of processing procedure of print execution processing.

### PREFERRED EMBODIMENTS OF THE INVENTION

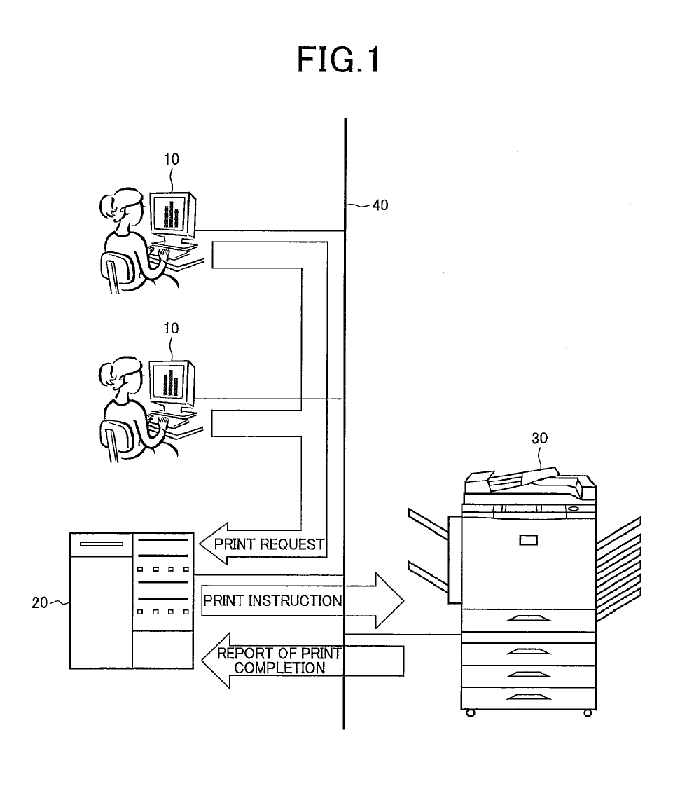

Hereinafter, detailed description will be given for an embodiment of the present invention with reference to drawings. FIG. 1 is a diagram showing an example of a printing system according to an embodiment of the present invention. In the printing system, a client apparatus 10, a server apparatus 20, and a multi-function peripheral 30 are connected via a network 40.

The client apparatus 10 is an apparatus that requests the server apparatus 20 to print a document, an image and the like. A party who requests a print job is charged according to the number of pages, the number of copies of a document, an image and the like, print unit price per page, presence or absence of post processing such as punching and the like. Then, in the present invention, charging information as described above is printed on inserting paper separating between a sheet on which printing is performed by a print job and a sheet on which printing is performed by a separate print job from the print job.

In this case, the server apparatus 20 that has accepted the print request calculates an amount to be charged to a party who requests the print job. The server apparatus 20 then transmits a control message instructing execution of the print job with information of the amount to the multi-function peripheral 30.

Subsequently, the multi-function peripheral 30 executes the print processing in which the print job and the print of the charging information on inserting paper are executed. After completing the print processing, then, the multi-function peripheral 30 transmits a message reporting completion of printing to the server apparatus 20.

In this manner, printing charging information on inserting paper enables the inserting paper not only to be used for separating sheets but also to be effectively utilized as a business document, thus facilitating assortment and shipment preparation of sheets, and making it possible to perform clerical work such as recording of expenses promptly and precisely.

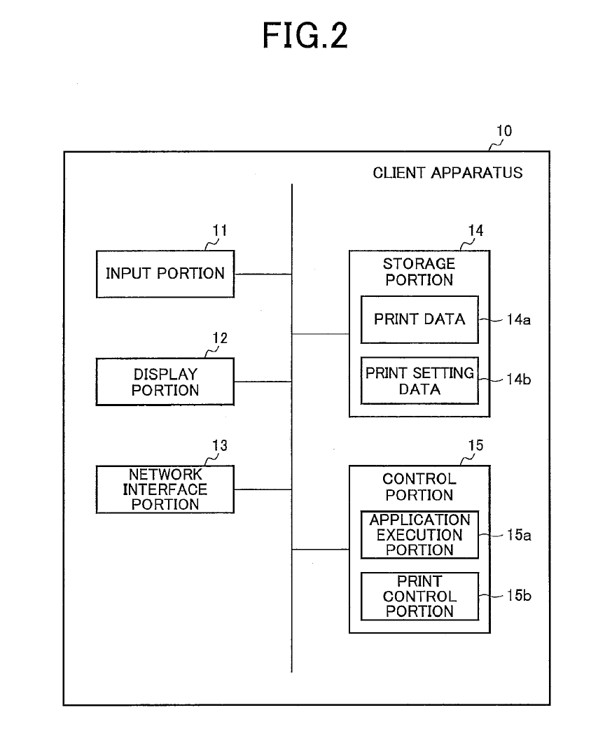

Next, description will be given for a configuration of the client apparatus 10 according to the embodiment of the present invention. FIG. 2 is a block diagram showing an example of the configuration of the client apparatus 10 according to the embodiment of the present invention. The client apparatus 10 is, for example, an apparatus such as a personal computer. The client apparatus 10 is provided with an input portion 11, a display portion 12, a network interface portion 13, a storage portion 14, and a control portion 15.

The input portion 11 is an input device such as a keyboard or a mouse. The display portion 12 is a display device such as a liquid crystal display. The network interface portion 13 is a communication device performing communication with another device such as the server apparatus 20 or the multi-function peripheral 30 via a network 40.

The storage portion 14 is a storage device such as a memory or a hard disk device. The storage portion 14 stores print data 14a, print setting data 14b and the like. The print data 14a is data such as a document or an image that is printed when a print job is requested of the server apparatus 20. The print setting data 14b is setting data in which print conditions is set when a print job is requested of the server apparatus 20. The setting data is set by a user who operates the client apparatus 10.

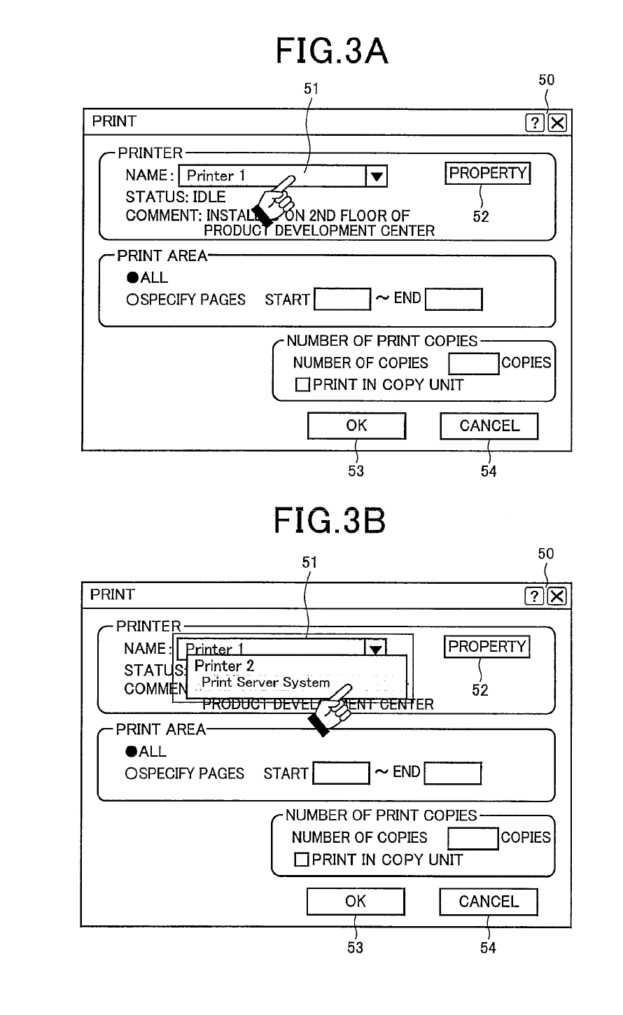

FIG. 3A and FIG. 3B are diagrams showing an example of a user interface 50 of a printer driver displayed on the client apparatus 10. As shown in FIG. 3A, a pull-down menu 51 is displayed on the user interface 50, in which a printer or the server apparatus 20 of which a print job is requested is selectable.

Then, as shown in FIG. 3B, when the server apparatus (in the example of FIG. 3B, “Print Server System”) is selected as the apparatus of which a print job is requested, and a property button 52 is further clicked by an operation of a mouse or the like of a user, a setting screen of print conditions is displayed. Note that, an OK button 53 and a cancel button 54 are buttons that accept from a user an execution instruction of print processing and a cancel instruction, respectively.

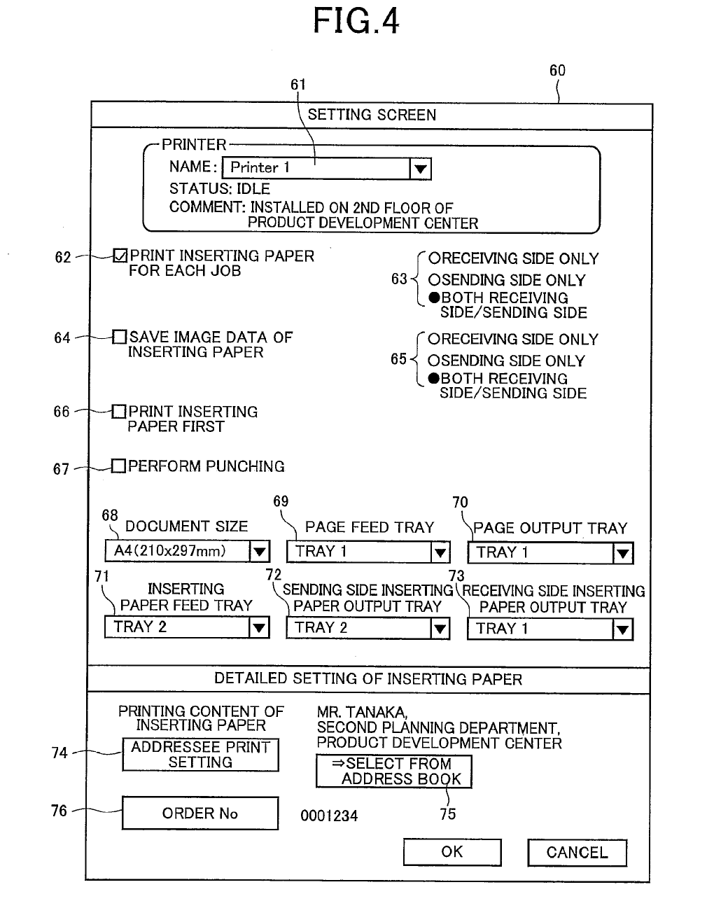

FIG. 4 is a diagram showing an example of a setting screen 60 of print conditions. On the setting screen 60, displayed are a pull down menu 61 that accepts a selection of a printer or a multi-function peripheral for performing printing from a user. Further, on the setting screen 60, a check box 62 that accepts from a user a setting of whether or not printing of inserting paper is performed per print job, radio buttons 63 that accept from a user a selection of, in the case of printing of inserting paper, whether or not only a document issued for a charged party (document for receiving side) is printed, whether or not only a document issued for a charging party (document for sending side) is printed, or both thereof are printed.

Further, on the setting screen 60, displayed are a check box 64 that accepts from a user a setting of whether or not image data of inserting paper is saved for transmitting the image data of the inserting paper to another apparatus by an electronic mail or FTP (File Transfer Protocol) communication, and radio buttons 65 that accept from a user a setting of, in the case of saving the image data of the inserting paper, whether only the image data of the inserting paper of the document issued for a charged party (document for receiving side) is saved, whether only the image data of the inserting paper of the document issued for a charging party (document for sending side) is saved, or both thereof are saved.

Moreover, on the setting screen 60, displayed are a check box 66 that accepts from a user a setting of whether printing of inserting paper is performed before executing a print job, or after executing a print job, a check box 67 that accepts from a user a setting of whether or not punching as post processing is performed on a printed sheet, and a pull down menu 68 that accepts from a user a setting of a size of a sheet on which printing is performed.

Further, on the setting screen 60, displayed are a pull down menu 69 that accepts from a user a selection of a tray for supplying a sheet used for printing of the print data 14a in executing a print job, and a pull down menu 70 that accepts from a user a selection of a tray to which a sheet on which printing of the print data 14a is executed is ejected.

Additionally, on the setting screen 60, displayed are, in the case of printing of inserting paper, a pull down menu 71 that accepts from a user a selection of a tray for supplying a sheet to be printed (for example, a letterhead sheet in a predetermined size on which company information such as a company name, a company address, and a company logo mark is printed), a pull down menu 72 that accepts from a user a selection of a tray to which inserting paper on which a document issued for a charging party (document for sending side) is printed is ejected, and a pull down menu 73 that accepts from a user a selection of a tray to which inserting paper on which a document issued for a charged party (document for receiving side) is printed is ejected.

Here, when, in the radio buttons 63, printing of only the document issued for a charged party (document for receiving side) is selected and printing on only one sheet of inserting paper is performed, the print control portion 15b determines whether or not a page output tray set in the pull down menu 70 and a receiving side inserting paper output tray set in the pull down menu 73 are set to a same tray, and in the case where these are not set to the same tray and inserting paper is not set to be ejected to the page output tray, performs processing to display an error message prompting a user to review the setting.

Similarly, when, in the radio buttons 63, printing of only the document issued for a charging party (document for sending side) is selected, and printing on only one sheet of inserting paper is performed, the print control portion 15b, which will be described below, determines whether or not a page output tray set in the pull down menu 70 and a sending side inserting paper output tray set in the pull down menu 72 are set to a same tray, and in the case where these are not set to the same tray and inserting paper is not set to be ejected to the page output tray, performs processing to display an error message prompting a user to review the setting.

Note that, when, in the radio buttons 63, printing of only the document issued for a charged party (document for receiving side) is selected and printing on only one sheet of inserting paper is performed, it may be configured that the print control portion 15b automatically sets the receiving side inserting paper output tray of the pull down menu 73 to a same tray as the page output tray set in the pull down menu 70.

Similarly, when, in the radio buttons 63, printing of only the document issued for a charging party (document for sending side) is selected, and printing on only one sheet of inserting paper is performed, it may be configured that the print control portion 15b automatically sets the sending side inserting paper output tray set in the pull down menu 72 to a same tray as the page output tray set in the pull down menu 70.

Further, on the setting screen 60, an addressee print setting button 74 for setting an addressee included in charging information to be printed on inserting paper is displayed. When the addressee print setting button 74 is clicked by operation of a mouse or the like of a user, a screen to accept an input of an addressee from a user is displayed and the addressee input by the user is set as an addressee to be printed on the inserting paper.

Moreover, on the setting screen 60, an addressee selection button 75 for selecting an addressee from an address book is displayed. When the addressee selection button 75 is clicked by an operation of a mouse or the like of a user, a transmission request of an address book is transmitted to the server apparatus 20. The address book transmitted in response to the transmission request is then received and the received address book is displayed. Further, when an addressee is selected by a user from the address book, the addressee is set as an addressee to be printed on inserting paper.

Additionally, on the setting screen 60, an order number button 76 for obtaining an order number for identification of each printing request is displayed. When the order number button 76 is clicked by an operation of a mouse or the like of a user, an assignment request of an order number is transmitted to the server apparatus 20. The order number assigned in response to the assignment request of an order number is obtained from the server apparatus 20, and the order number is displayed.

Then, in the print setting data 14b shown in FIG. 2, various settings that are performed by a user using the pull down menus 61 and 68 to 73, the check boxes 62, 64, 66 and 67, the radio buttons 63 and 65, the addressee print setting button 74, an addressee selection button 75 and the order number button 76 are registered.

The control portion 15 is a control device such as a CPU (Central processing Unit) for controlling respective function portions of the client apparatus 10. The control portion 15 is provided with an application execution portion 15a and a print control portion 15b.

The application execution portion 15a is a processing portion that executes an application program for creating or editing a document, an image and the like. The print control portion 15b is a processing portion that controls, when accepting a print request of a document, an image and the like from a user in an application program executed by the application execution portion 15a, the multi-function peripheral 30 to perform execution control of print processing.

For example, in the case of accepting a print request from a user, the print control portion 15b controls the display portion 12 to display the user interface 50 shown in FIG. 3A and FIG. 3B and the setting screen 60 of print conditions shown in FIG. 4, and accepts various settings from the user.

Additionally, in the case of performing a print request of the print data 14a directly to the multi-function peripheral 30 without the server apparatus 20, the print control portion 15b transmits a print job execution request including the print data 14a and various settings accepted from a user to the multi-function peripheral 30 via the network interface portion 13.

Further, in the case of performing a print request of the print data 14a to the multi-function peripheral 30 via the server apparatus 20, the print control portion 15b transmits a print job execution request including the print data 14a and various settings accepted from a user to the server apparatus 20 via the network interface portion 13.

Moreover, when the addressee selection button 75 shown in FIG. 4 is clicked by an operation of a mouse or the like of a user, the print control portion 15b transmits a transmission request of an address book to the server apparatus 20, and receives the address book transmitted from the server apparatus 20 consequently. Then, when an addressee is selected by a user from the address book, the print control portion 15b sets the addressee as an addressee to be printed on inserting paper.

Additionally, when the order number button 76 shown in FIG. 4 is clicked by an operation of a mouse or the like of the user, the print control portion 15b transmits an assignment request of an order number to the server apparatus 20. Then, the print control portion 15b receives the consequently assigned order number from the server apparatus 20 and sets the received order number as an order number to be printed on inserting paper.

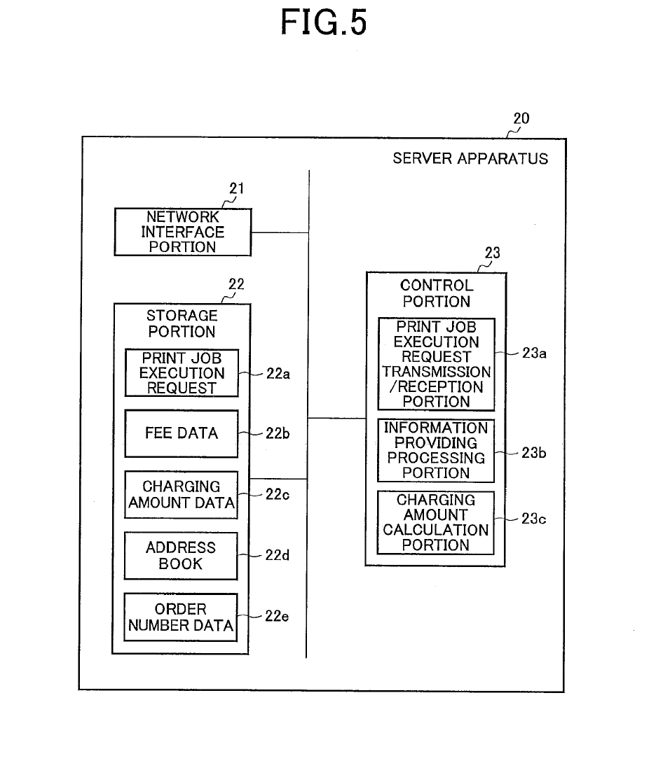

Next, description will be given for a configuration of the server apparatus 20 according to the embodiment of the present invention. FIG. 5 is a block diagram showing an example of a configuration of the server apparatus 20 according to the embodiment of the present invention. The server apparatus 20 is provided with a network interface portion 21, a storage portion 22, and a control portion 23.

The network interface portion 21 is a communication device that performs communication with another device such as a client apparatus 10 or a multi-function peripheral 30 via the network 40. The storage portion 22 is a storage device such as a memory or a hard disk device. The storage portion 22 stores a print job execution request 22a, fee data 22b, charging amount data 22c, an address book 22d, order number data 22e and the like.

The print job execution request 22a is data of a print job execution request received from the client apparatus 10. The print job execution request 22a includes the print data 14a and various settings of a print job for printing of the print data 14a.

The fee data 22b is data used to calculate a charging amount to be charged to a user who requested printing. The fee data 22b include data necessary to calculate a charging amount such as a print fee per page, a fee for post processing such as punching and the like.

The charging amount data 22c is data in which a charging amount calculated by a charging amount calculation portion 23c, which will be described below, is stored. The address book 22d is data of an address book in which an addressee of a party to be charged is registered. The order number data 22e is data of an order number assigned to each print job.

The control portion 23 is a control device such as a CPU for controlling each function portion of the server apparatus 20. The control portion 23 is provided with a print job execution request transmission/reception portion 23a, an information providing processing portion 23b, and the charging amount calculation portion 23c.

The print job execution request transmission/reception portion 23a is a processing portion that receives a print job execution request from the client apparatus 10 and stores the print job execution request in the storage portion 22 as well as reading the print job execution request stored in the storage portion 22 to transmit the read print job execution request to the multi-function peripheral 30. The print job execution request transmission/reception portion 23a, at the time of transmitting the print job execution request to the multi-function peripheral 30, also transmits data of a charging amount calculated by the charging amount calculation portion 23c that will be described next.

The information providing processing portion 23b is a processing portion that provides order information of a print job to the client apparatus 10. Specifically, when receiving a transmission request of the address book 22d from the client apparatus 10, the information providing processing portion 23b reads the address book 22d from the storage portion 22 and transmits the read address book 22d to the client apparatus 10.

Further, when receiving an assignment request of an order number of a print job from the client apparatus 10, the information providing processing portion 23b reads the order number data 22e from the storage portion 22, assigns an order number other than the order number that has been already registered in the order number data 22e to the print job, and transmits the assigned order number to the client apparatus 10. In addition, the information providing processing portion 23b registers the newly assigned order number in the order number data 22e.

The charging amount calculation portion 23c is a processing portion that calculates a charging amount to be charged to a user who requested printing. For example, the charging amount calculation portion 23c reads the print job execution request 22a and the fee data 22b from the storage portion 22b, and calculates a charging amount using information of the number of pages and information of present/absence of post processing included in the print job execution request 22a, and information of a print fee per page and a fee for post processing included in the fee data 22b.

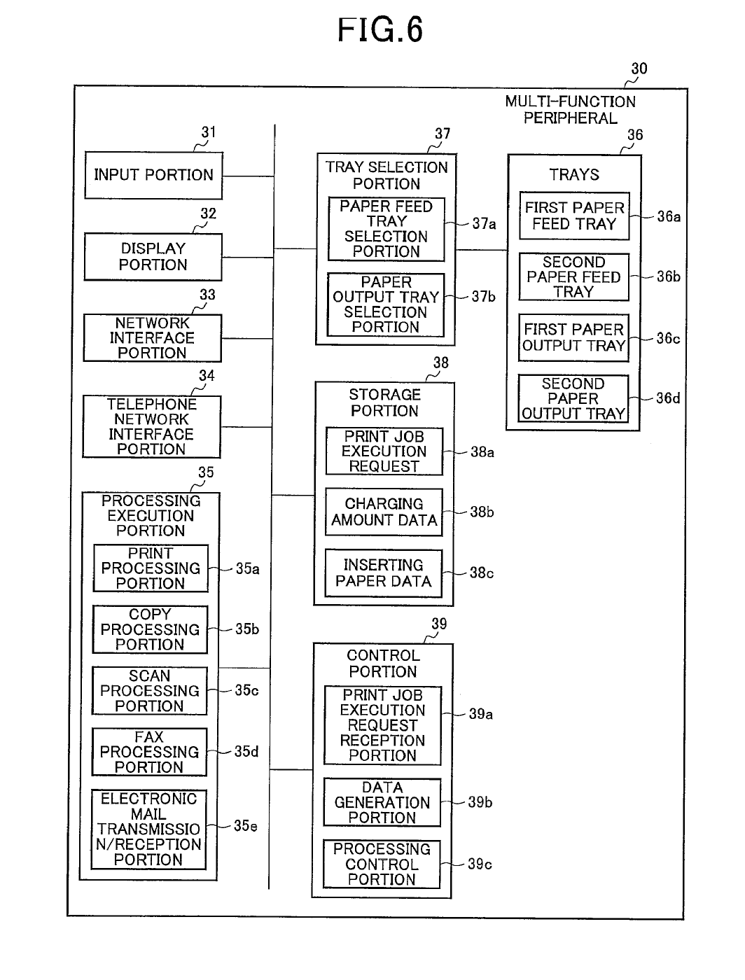

Next, description will be given for a configuration of the multi-function peripheral 30 according to the embodiment of the present invention. FIG. 6 is a block diagram showing an example of a configuration of the multi-function peripheral 30 according to the embodiment of the present invention. The multi-function peripheral 30 is provided with an input portion 31, a display portion 32, a network interface portion 33, a telephone network interface portion 34, a processing execution portion 35, trays 36, a tray selection portion 37, a storage portion 38 and a control portion 39.

The input portion 31 is an input device such as a touch pad. The display portion 32 is a display device such as a liquid crystal panel. The network interface portion 33 is a communication device that performs communication with another device such as the client apparatus 10 or the server apparatus 20 via the network 40. The telephone network interface portion 34 is a communication device that performs transmission/reception of a facsimile to/from another facsimile via a telephone network.

The processing execution portion 35 is a processing portion that executes various image formation processing. The processing execution portion 35 is provided with a print processing portion 35a, a copy processing portion 35b, a scan processing portion 35c, a FAX processing portion 35d, and an electronic mail transmission/reception processing portion 35e.

The print processing portion 35a is a processing portion that executes a print job. The copy processing portion 35b is a processing portion that performs copy processing of a document. The scan processing portion 35c is a processing portion that performs scan processing of a document. When performing copy processing, the scan processing portion 35c requests the copy processing portion 35b to scan a document, and requests the print processing portion 35a to print image data obtained consequently. The FAX processing portion 35d is a processing portion that performs transmission/reception processing of a facsimile. The electronic mail transmission/reception processing portion 35e is a processing portion that performs transmission/reception processing of an electronic mail via the network interface portion 33.

The trays 36 are trays to hold a sheet supplied for printing, and to hold a sheet ejected after printing. The trays 36 are provided with a first paper feed tray 36a, a second paper feed tray 36b, a first paper output tray 36c, and a second paper output tray 36d.

Each of the first paper feed tray 36a and the second paper feed tray 36b is a tray to hold a sheet supplied for printing. Each of the first paper output tray 36c and the second paper output tray 36d is a tray to hold a sheet ejected after printing.

The tray selection portion 37 is a processing portion that selects a tray holding a sheet supplied for printing and a tray to which a printed sheet is ejected. The tray selection portion 37 is provided with a paper feed tray selection portion 37a and a paper output tray selection portion 37b.

The paper feed tray selection portion 37a is a processing portion that selects a paper feed tray holding a sheet supplied for printing from among the first paper feed tray 36a and the second paper feed tray 36b based on setting data of a paper feed tray. The paper output tray selection portion 37b is a processing portion that selects a paper output tray to which a printed sheet is ejected from among the first paper output tray 36c and the second paper output tray 36d based on setting data of a paper output tray.

The storage portion 38 is a storage device such as a memory or a hard disk device. The storage portion 38 stores a print job execution request 38a, charging amount data 38b, inserting paper data 38c and the like.

The print job execution request 38a is data of a print job execution request received from the server apparatus 20. The print job execution request 38a includes the print data 14a and various settings of a print job for printing of the print data 14a. The charging amount data 38b is data of a charging amount calculated and transmitted by the server apparatus 20. The inserting paper data 38c is image data generated by a data generation portion 39b, which will be described below.

The control portion 39 is a control device such as a CPU for controlling each function portion of the multi-function peripheral 30. The control portion 39 is provided with a print job execution request reception portion 39a, a data generation portion 39b, and a processing control portion 39c.

The print job execution request reception portion 39a is a processing portion that receives a print job execution request from the server apparatus 20 and stores the print job execution request in the storage portion 38. The data generation portion 39b is a processing portion that generates image data to be printed on inserting paper. Specifically, the data generation portion 39b reads the print job execution request 38a from the storage portion 38, generates image data from addressee information, charging information, order number information and the like included in the print job execution request 38a, and stores the generated image data in the storage portion 38.

The image data stored in the storage portion 38 is printed by the print processing portion 35a, transmitted by the FAX processing portion 35d, or attached to an electronic mail as a file and transmitted by the electronic mail transmission/reception processing portion 35e.

The processing control portion 39c is a processing portion that controls the print processing portion 35a, the copy processing portion 35b, the scan processing portion 35c, the FAX processing portion 35d and the electronic mail transmission/reception processing portion 35e to execute print processing, copy processing, scan processing, facsimile transmission/reception processing, and electronic mail transmission/reception processing.

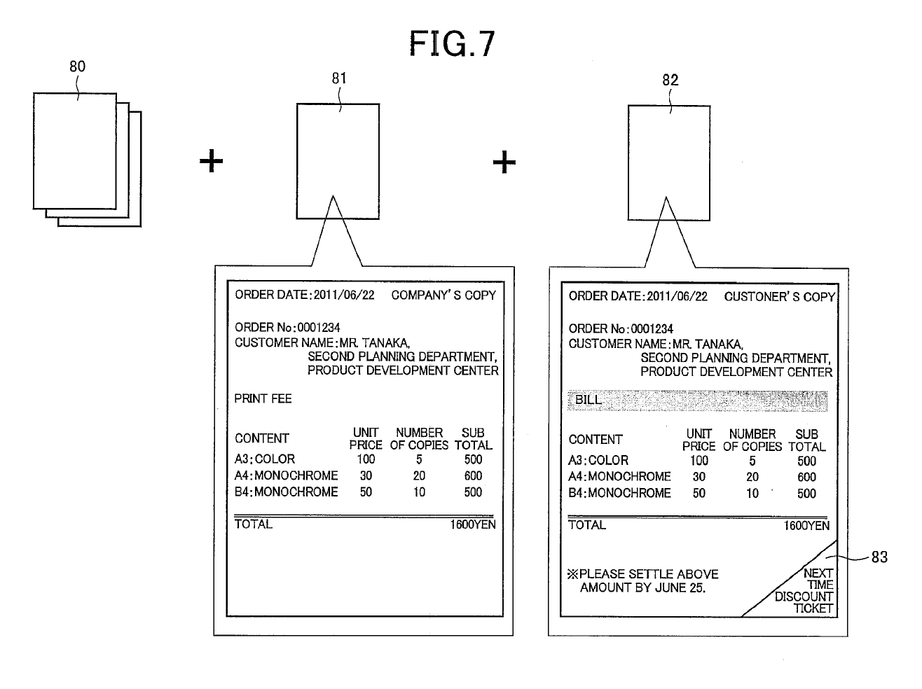

FIG. 7 is a diagram showing an example of image data printed by print processing according to the embodiment of the present invention. In the print processing, image data of a document or an image 80 that is requested to be printed by a user, image data of a document issued for a charging party (document for sending side) 81, and image data of a document issued for a charged party (document for receiving side) 82 are generated.

Then, in the image data of the document 81 and 82, addressee information, charging information, order number information and the like are included. Thereby, in a case where the document 82 is printed on inserting paper, the inserting paper is able to be used directly as a bill issued for a charged party, thus making it possible to perform clerical work promptly and precisely.

Furthermore, the document 82 includes a discount ticket 83. A charged party is able to receive a discount service by submitting the discount ticket 83 printed on the inserting paper together with a bill at the time of next payment.

Here, the document 81 includes charging information similar to that of the document 82. In this way, the documents 81 and 82 including similar charging information are printed on inserting paper, one of which is thereby able to be used as a bill issued for a charged party and the other one is able to be used for a charging party's copy.

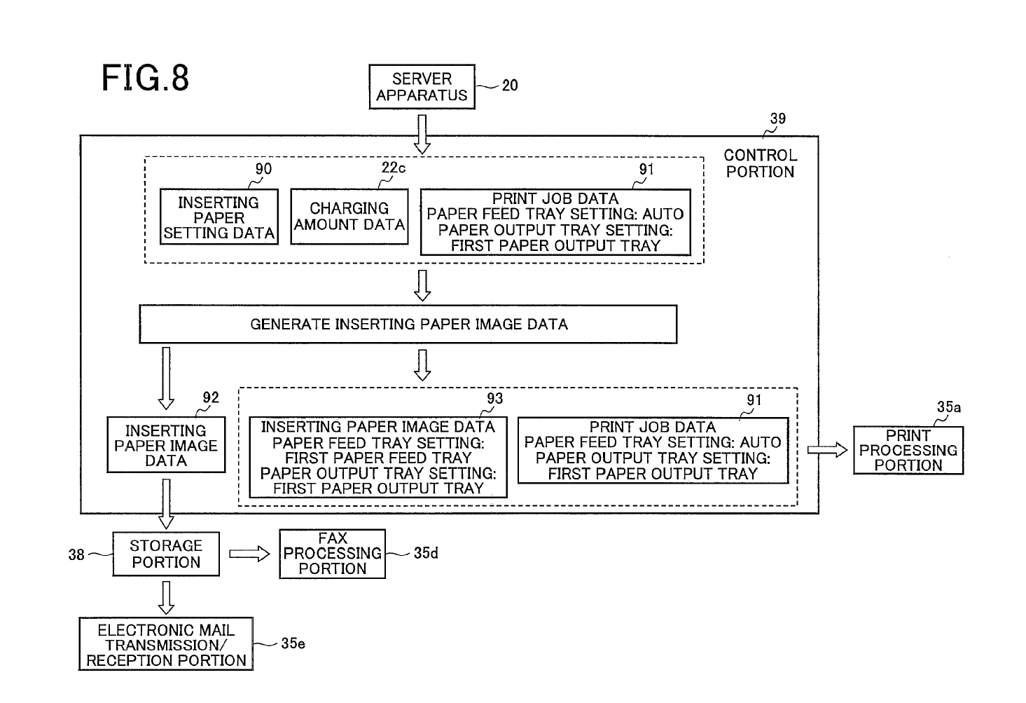

FIG. 8 is a diagram showing an example of print control processing performed by the control portion 39 of the multi-function peripheral 30. The print job execution request reception portion 39a of the control portion 39 receives a print job execution request from the server apparatus 20. In the print job execution request, inserting paper setting data 90 and print job data 91 are included in addition to the charging amount data 22c calculated by the server apparatus 20.

The inserting paper setting data 90 then includes data such as:

setting data as to whether or not printing of inserting paper is performed for each print job;

setting data that is set as to whether a document issued for a charged party (document for receiving side) is printed on inserting paper, whether a document issued for a charging party (document for sending side) is printed on inserting paper, or whether both thereof are printed on separate inserting paper;

setting data as to whether or not image data of inserting paper is saved for transmitting the image data of the inserting paper to another device;

setting data of, in the case of saving image data of inserting paper, whether image data of inserting paper of a document issued for a charged party (document for receiving side) is saved, whether image data of inserting paper of a document issued for a charging party (document for sending side) is saved, or whether both thereof are saved;

setting data as to whether printing of inserting paper is performed before executing a print job, or after executing a print job;

Setting data of a paper feed tray that supplies inserting paper;

setting data of a tray to which inserting paper on which a document issued for a charging party (document for sending side) is printed is ejected;

setting data of a tray to which inserting paper on which a document issued for a charged party (document for receiving side) is printed is ejected; and

setting data of an addressee and an order number printed on inserting paper.

Furthermore, the print job data 91 includes data such as:

print data 14a received from the client apparatus 10 via the server apparatus 20;

setting data setting a printer or a multi-function peripheral for printing;

setting data as to whether or not punching is performed;

setting data setting a size of a sheet on which printing is performed;

setting data of a tray supplying a sheet used for printing a document or the like in executing a print job; and

setting data of a tray to which a sheet on which printing is performed is ejected.

Then, the data generation portion 39b of the control portion 39 performs processing to generate image data printed on inserting paper using the inserting paper setting data 90 and the charging amount data 22c. An example of FIG. 8 shows a case where on the setting screen 60 shown in FIG. 4, the check box 64 is checked, and further, among the radio buttons 65, the button of saving only image data of inserting paper of a document issued for a charging party (document for sending side) is selected.

In this case, the data generation portion 39b generates inserting paper image data 92 of a document issued for a charging party (document for sending side) and stores the generated image data 92 in the storage portion 38. The image data 92 is subsequently transmitted by facsimile by the FAX processing portion 35d, or attached to an electronic mail as a file to be transmitted by the electronic mail transmission/reception processing portion 35e. Thereby, the charging party is able to easily obtain image data of inserting paper regardless of location.

Further, the data generation portion 39b generates inserting paper image data 93 of a document issued for a charged party (document for receiving side). In the example of FIG. 8, it is assumed that the check box 66 is not checked on the setting screen 60 shown in FIG. 4. In this case, the processing control portion 39c of the control portion 39 first outputs print job data 91 to the print processing portion 35a and controls the print processing portion 35a to print the image data 14a, and thereafter, outputs the inserting paper image data 93 to the print processing portion 35a and controls the print processing portion 35a to print the inserting paper image data 93.

In the print job data 91 shown in FIG. 8, “auto” is set in setting data of a paper feed tray supplying a sheet used for printing the print data 14a. The setting data is set by a user in the pull down menu 69 on the setting screen 60 shown in FIG. 4. In this case, a sheet is supplied from a paper feed tray holding a sheet corresponding to a document size set by the user by operating the pull down menu 68 shown in FIG. 4.

Further, in the print job data 91 shown in FIG. 8, a “first paper output tray” is set in setting data of a paper output tray to which a sheet on which printing is performed is ejected. The setting data is set by a user in the pull down menu 70 on the setting screen 60 shown in FIG. 4. Here, the “first paper output tray” corresponds to a “tray 1” displayed in the pull down menu 70 on the setting screen 60 shown in FIG. 4. In this case, a printed sheet is ejected to the first paper output tray 36c shown in FIG. 6.

Further, setting data of a paper feed tray supplying inserting paper for printing is added to the inserting paper image data 93, and the paper feed tray is set to the “first paper feed tray” in the setting data shown in FIG. 8. This is set by a user in the pull down menu 71 on the setting screen 60 shown in FIG. 4. Here, the “first paper feed tray” corresponds to a “tray 2” displayed in the pull down menu 71 in FIG. 4. In this case, a printing sheet is supplied from the second paper feed tray 36b shown in FIG. 6.

Furthermore, setting data of a paper output tray to which inserting paper on which a document issued for a charged party (document for receiving side) is printed is added to the inserting paper image data 93, and in the setting data shown in FIG. 8, the paper output tray is set to the “first paper output tray”. This is set by a user in the pull down menu 73 on the setting screen 60 shown in FIG. 4. Here, the “first paper output tray” corresponds to a “tray 1” displayed in the pull down menu 73 in FIG. 4. In this case, printed inserting paper is ejected to the first paper output tray 36c shown in FIG. 6.

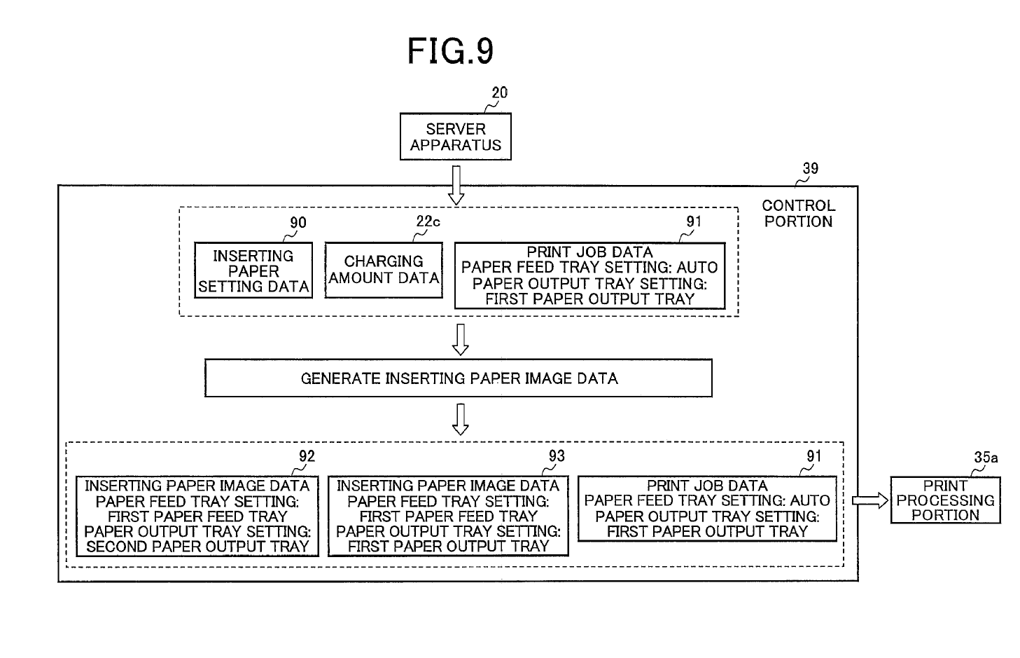

FIG. 9 is a diagram showing another example of the print control processing performed by the control portion 39 of the multi-function peripheral 30. In this example, differently from the case of FIG. 8, it is assumed that the check box 64 is not checked on the setting screen 60 shown in FIG. 4. Additionally, it is assumed that by an operation of the pull down menu 71 by a user, the first paper feed tray 36a shown in FIG. 6 is selected as a paper feed tray supplying inserting paper for printing, and by an operation of the pull down menu 72 by a user, the second paper output tray 36d shown in FIG. 6 is selected as a paper output tray to which inserting paper on which a document issued for a charging party (document for sending side) is printed is ejected.

In this case, the data generation portion 39b of the control portion 39 generates the inserting paper image data 92 of a document issued for a charging party (document for sending side), and the inserting paper image data 93 of a document issued for a charged party (document for receiving side) using the inserting paper setting data 90 and the charging amount data 22c.

Note that, in the example of FIG. 9, it is assumed that the check box 66 is not checked on the setting screen 60 shown in FIG. 4. In this case, the processing control portion 39c of the control portion 39 outputs the print job data 91 to the print processing portion 35a at first and controls the print processing portion 35a to print the print data 14a. Subsequently, the processing control portion 39c outputs the inserting paper image data 93 to the print processing portion 35a and controls the print processing portion 35a to print the inserting paper image data 93. Furthermore, the processing control portion 39c outputs the inserting paper image data 92 to the print processing portion 35a and controls the print processing portion 35a to print the inserting paper image data 92.

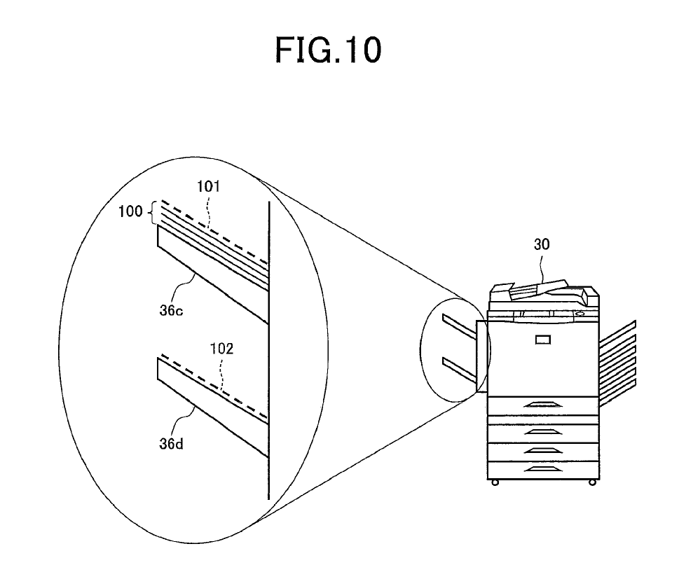

FIG. 10 is a diagram showing an ejected state of a sheet after the print processing shown in FIG. 9. In the example of FIG. 9, a sheet on which the print data 14a is printed by a print job requested by a user is set to be ejected to the first paper output tray 36c, inserting paper on which the inserting paper image data 93 is printed is set to be ejected to the first paper output tray 36c, and inserting paper on which the inserting paper image data 92 is printed is set to be ejected to the second paper output tray 36d.

Then, since the print processing is performed in the order of the print data 14a, the inserting paper image data 93, and the inserting paper image data 92, a sheet 100 on which the print data 14a is printed is ejected to the first paper output tray 36c, and thereon inserting paper 101 on which the inserting paper image data 93 is printed is ejected, and inserting paper 102 on which the inserting paper image data 92 is printed is ejected to the second paper output tray 36d.

In this way, by ejecting the inserting paper 101 on the sheet 100, even when a next print job is executed, it is possible to easily distinguish a sheet printed by a different print job.

Further, inserting paper 102 on which the inserting paper image data 92 is printed is ejected to the second paper output tray 36d that is separate from that of the inserting paper 101 on which the inserting paper image data 93 is printed, so that inserting paper on which a document issued for a charging party (document for sending side) is printed is able to be easily taken out.

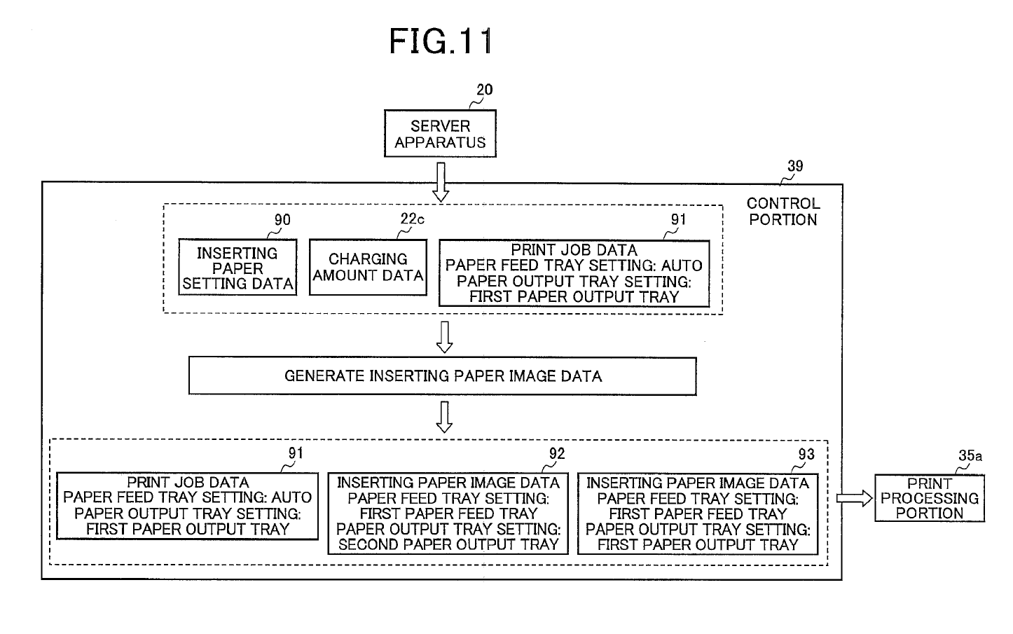

FIG. 11 is a diagram showing another example of the print control processing performed by the control portion 39 of the multi-function peripheral 30. In this example, differently from the case of FIG. 9, on the setting screen 60 shown in FIG. 4, it is assumed that the check box 66 is checked.

In this case, the data generation portion 39b of the control portion 39 generates the inserting paper image data 92 of a document issued for a charging party (document for sending side), and the inserting paper image data 93 of a document issued for a charged party (document for receiving side) using the inserting paper setting data 90 and the charging amount data 22c.

Then, the processing control portion 39c of the control portion 39 outputs the inserting paper image data 93 to the print processing portion 35a at first and controls the print processing portion 35a to print the inserting paper image data 93. Subsequently, the processing control portion 39c outputs the inserting paper image data 92 to the print processing portion 35a and controls the print processing portion 35a to print the inserting paper image data 92. Furthermore, the processing control portion 39c outputs the print job data 91 to the print processing portion 35a and controls the print processing portion 35a to print the print data 14a.

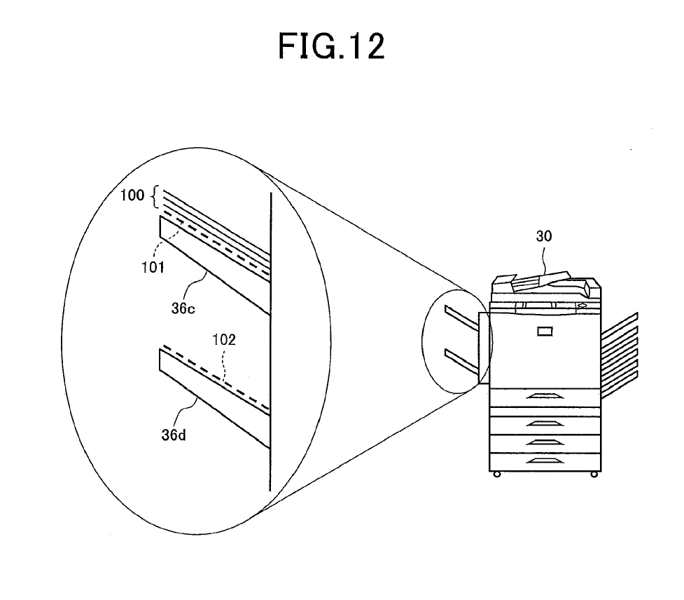

FIG. 12 is a diagram showing an ejected state of a sheet after the print processing shown in FIG. 11. In the example of FIG. 11, inserting paper on which the inserting paper image data 93 is printed is set to be ejected to the first paper output tray 36c, inserting paper on which the inserting paper image data 92 is printed is set to be ejected to the second paper output tray 36d, and a sheet on which the print data 14a is printed by a print job requested by a user is set to be ejected to the first paper output tray 36c.

Then, since the print processing is performed in the order of the inserting paper image data 93, the inserting paper image data 92 and the print data 14a, the inserting paper 101 on which the inserting paper image data 93 is printed is ejected to the first paper output tray 36c, the inserting paper 102 on which the inserting paper image data 92 is printed is ejected to the second paper output tray 36d, and on the inserting paper 101, the sheet 100 on which the print data 14a is printed is ejected.

This makes it possible, even when a separate print job has been executed earlier, to easily distinguish sheets printed by different print jobs. Further, since the inserting paper 102 on which a document issued for a charging party (document for sending side) is printed is ejected to the second paper output tray 36d that is different from the first paper output tray 36c holding the sheet 100 and the inserting paper 101, the inserting paper 102 is thus able to be taken out easily.

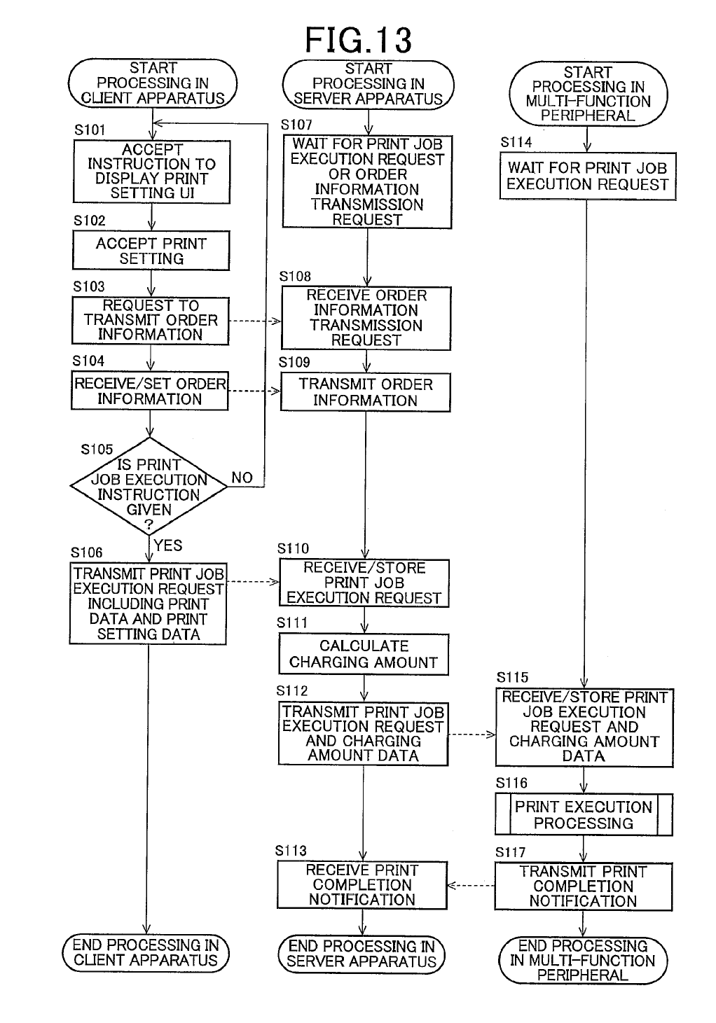

Next, description will be given for an example of processing procedure of print processing according to the embodiment of the present invention. FIG. 13 is a flowchart showing an example of processing procedure of the print processing according to the embodiment of the present invention. First, the application execution portion 15a of the client apparatus 10 accepts an instruction to display a user interface (UI) for performing print setting shown in FIG. 3A and FIG. 3B from a user performing a creation/editorial operation of a document or the like (step S101).

The print control portion 15b then accepts a setting of a print job and a print setting of inserting paper from a user on the setting screen 60 of print conditions shown in FIG. 4 (step S102).

Subsequently, the print control portion 15b detects that the addressee selection button 75 or the order number button 76 shown in FIG. 4 is clicked by an operation of a mouse or the like of a user, and requests the server apparatus 20 to transmit order information such as an address book or an order number (step S103).

Meanwhile, the information providing processing portion 23b of the server apparatus 20 waits for an order information transmission request from the client apparatus 10, and the print job execution request transmission/reception portion 23a waits for a print job execution request from the client apparatus 10 (step S107).

Then, when the order information transmission request is transmitted from the client apparatus 10, the information providing processing portion 23b receives the order information transmission request (step S108). Subsequently, the information providing processing portion 23b transmits the order information requested by the client apparatus 10 to the client apparatus 10 (step S109).

Specifically, when transmission of an address book is requested in the order information transmission request by the client apparatus 10, the information providing processing portion 23b reads the address book 22d from the storage portion 22 and transmits the read address book 22d to the client apparatus 10. Further, when transmission of an order number is requested by the client apparatus 10 in the order information transmission request, the information providing processing portion 23b reads the order number data 22e from the storage portion 22 and transmits an order number other than the order number that has been already registered in the order number data 22e to the client apparatus 10 as an order number to be newly assigned to a print job.

The print control portion 15b of the client apparatus 10 receives the order information transmitted from the server apparatus 20 and sets the order number included in the order information as an order number to be printed on inserting paper as well as setting, when an address book is included in the order information, an addressee selected by a user using the address book as an addressee to be printed on inserting paper (step S104).

Thereafter, the print control portion 15b determines whether or not an execution instruction of a print job is accepted from a user (step S105). When the execution instruction of the print job is not accepted from a user, and execution of a print job is cancelled by the cancel button 54 shown in FIG. 3A and FIG. 3B being clicked or the like by an operation of a mouse or the like of a user (in the case of No at step S105), the process shifts to the step S101 to continue subsequent processing.

When the OK button 53 shown in FIG. 3A and FIG. 3B is clicked or the like by an operation of a mouse or the like of a user and the execution instruction of a print job is accepted from a user (in the case of YES at step S105), the print control portion 15b transmits a print job execution request including the print data 14a requested for printing by a user and the print setting data accepted at step S102 to the server apparatus 20 (step S106).

When the print job execution request is transmitted from the client apparatus 10, the print job execution request transmission/reception portion 23a of the server apparatus 20 receives the print job execution request and stores the print job execution request in the storage portion 22 (step S110).

The charging amount calculation portion 23c then calculates a charging amount to be charged to the user who requested printing by a method described above (step S111). Thereafter, the print job execution request transmission/reception portion 23a transmits the print job execution request received from the client apparatus and data of a charging amount calculated by the charging amount calculation portion 23c to the multi-function peripheral 30 (step S112).

On the other hand, the print job execution request reception portion 39a of the multi-function peripheral 30 waits for transmission of the print job execution request from the client apparatus 10 (step S114). When the print job execution request is transmitted with the data of the charging amount from the server apparatus 20, the print job execution request reception portion 39a receives the print job execution request and the data of the charging amount, and stores the print job execution request and the data of the charging amount in the storage portion 38 (step S115).

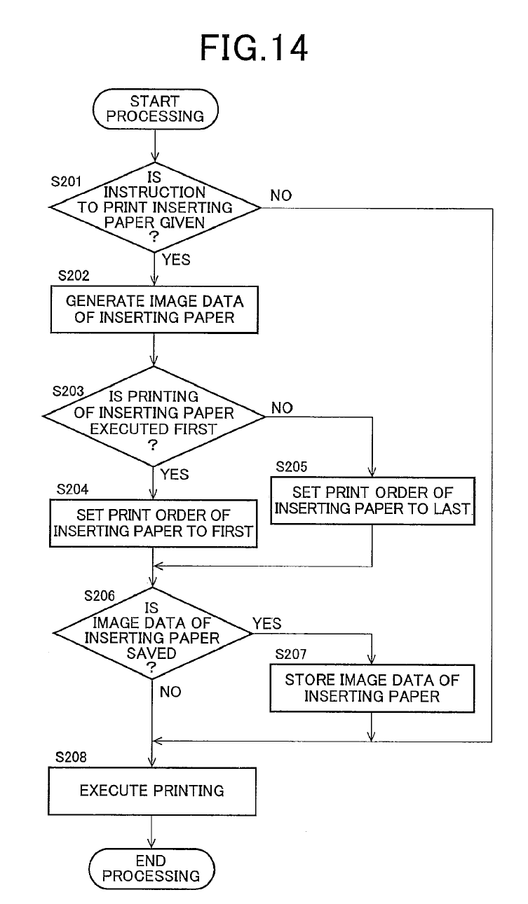

Then, the data generation portion 39b, the processing control portion 39c, the print processing portion 35a perform print execution processing of print data 14a requested to be printed by a user and inserting paper (step S116). Description will be given in detail for the print execution processing with reference to FIG. 14.

After completion of printing, the print job execution request reception portion 39a transmits print completion notification showing that printing is completed to the server apparatus 20 (step S117). The print job execution request transmission/reception portion 23a of the server apparatus 20 then receives the print completion notification (step S113), and the print processing is completed.

Next, description will be given for an example of processing procedure of the print execution processing shown at step S116 of FIG. 13. FIG. 14 is a flowchart showing an example of processing procedure of the print execution processing. First, the data generation portion 39b of the multi-function peripheral 30 determines whether or not setting data instructing printing of inserting paper is included in the print job execution request (step S201).

When the setting data instructing printing of inserting paper is not included in the print job execution request (in the case of NO at step S201), the print processing portion 35a executes printing of the print data 14a included in the print job execution request (step S208).

When the setting data instructing printing of inserting paper is included in the print job execution request (in the case of YES at step S201), the data generation portion 39b generates image data of inserting paper using data of an addressee and an order number and data included in the print job execution request and data of a charging amount (step S202).

Subsequently, the processing control portion 39c determines whether or not the setting data instructing to first execute printing of inserting paper is included in the print job execution request (step S203). When the setting data instructing to first execute printing of inserting paper is included in the print job execution request (in the case of YES at step S203), the processing control portion 39c sets printing order of inserting paper to “first” (step S204).

When the setting data instructing to first execute printing of inserting paper is not included in the print job execution request (in the case of NO at step S203), the processing control portion 39c sets printing order of inserting paper to “last” (step S205).

After the processing at step S204 or step S205, the processing control portion 39c determines whether or not setting data instructing to save image data of inserting paper is included in the print job execution request (step S206).

When the setting data instructing to save image data of inserting paper is included in the print job execution request (in the case of YES at step S206), the processing control portion 39c stores image data of inserting paper in the storage portion 38 (step S207). The image data stored in the storage portion 38 is thereafter transmitted by facsimile by the FAX processing portion 35d, or attached to an electronic mail as a file and transmitted by the electronic mail transmission/reception processing portion 35e.

At step S206, when the setting data instructing to save image data of inserting paper is not included in the print job execution request (in the case of NO at step S206), or after the processing at step S207, the processing control portion 39c performs printing of the print data 14a requested for printing from a user and printing of inserting paper (step S208).

Specifically, when the print order of the inserting paper is set to “first” at step S204, the processing control portion 39c controls the print processing portion 35a to first execute printing of inserting paper, and to thereafter execute printing of the print data 14a. Further, when the print order of the inserting paper is set to “last” at step S205, the processing control portion 39c controls the print processing portion 35a to first execute printing of the print data 14a, and to thereafter execute printing of inserting paper.

Furthermore, when setting data of a paper feed tray and a paper output tray is included in the print job execution request, the processing control portion 39c controls the paper feed tray selection portion 37a corresponding to the setting data so that a sheet used for printing is supplied from the first paper feed tray 36a or the second paper feed tray 36b, and further controls the paper output tray selection portion 37b so as to eject a printed sheet to the first paper output tray 36c or the second paper output tray 36d.

For example, the processing control portion 39c performs control such that plain paper is held in the first paper feed tray 36a, a letterhead sheet is held in the second paper feed tray 36b, a sheet for printing the print data 14a is supplied from the first paper feed tray 36a and a sheet for printing inserting paper is supplied from the second paper feed tray 36b. This makes it possible to use inserting paper directly as a business document, and to perform clerical work promptly and precisely.

Further, the processing control portion 39c performs control so that inserting paper on which a document issued for a charged party (document for receiving side) is printed is ejected to the first paper output tray 36c to which a sheet on which the print data 14a is printed is ejected, and inserting paper on which a document issued for a charging party (document for sending side) is printed is ejected to the second paper output tray 36d. This makes it possible to easily take out the inserting paper on which a document issued for a charging party (document for sending side) is printed.

In this manner, description has been given mainly for embodiments of the printing system and the printing method so far, however, the present invention is not limited to these embodiments, and the present invention may be implemented as a form of a computer program for realizing functions of the printing system, or a form of a computer-readable recording medium in which the computer program is recorded.

Here, as the recording medium, ones in various forms are able to be employed including disc types (for example, a magnetic disc, an optical disc and the like), card types (for example, a memory card, an optical card and the like), semiconductor memory types (for example, a ROM, a nonvolatile memory and the like), tape types (for example, a magnetic tape, a cassette tape and the like), and the like.

Computer programs that realize the functions of the printing system of the above-described present embodiment or computer programs that cause a computer to execute the printing method are recorded on these recording media to be distributed, thereby making it possible to improve cost reduction, portability and general versatility.

Subsequently, a computer is equipped with the above-described recording medium, then the computer program that is recorded in the recording medium is read by the computer to be stored in a memory, and a processor provided in the computer (CPU: Central Processing Unit, MPU: Micro Processing Unit) reads and executes the computer program from the memory, so that it is possible to realize the functions of the printing system according to the present embodiment and execute the printing method.

Additionally, the present invention is not limited to the above-described embodiments, and various changes and modifications are able to be made without departing from the spirit of the present invention. For example, the number of printing sheets of the inserting paper is not limited to two sheets including inserting paper on which a document issued for a charged party is printed and inserting paper on which a document issued for a charging party is printed, and may be more than two sheets.

Further, in the above-described embodiment, though charging information is printed on inserting paper, relevant information to an image to be printed may be printed on the inserting paper in addition to the charging information. The relevant information includes information of a thumbnail image of the image to be printed, the total number of the images to be printed and the like.

By printing the thumbnail image of the image to be printed, the total number of the images to be printed and the like, it is possible to make an assortment operation after printing or the like easier, and by providing the relevant information to an operator, it is possible to make an operation of the operator efficient.

Furthermore, in the above-described embodiment, the settings of the check box 62 and the settings of the radio buttons 63 shown in FIG. 4 are performed independently from one another, however, in conjunction with checking of the check box 62 by a user so as to perform printing of charging information on inserting paper, the print control portion 15b may automatically set the radio buttons 63 to the setting for printing both of a document issued for a charged party (document for receiving side) and a document issued for a charging party (document for sending side). This processing is assumed to be performed by the processing at step S102 shown in FIG. 13. Thereby, it is possible for a user to facilitate print setting operation of inserting paper.

Moreover, in conjunction with checking of the check box 62 by a user so as to perform printing of charging information on inserting paper, the print control portion 15b may perform a setting of print processing selected with the radio buttons 63 by a user, as well as automatically checking the check box 64 to automatically perform a setting to save image data of inserting paper as a file.

Further, in conjunction with checking of the check box 62 by a user so as to perform printing of charging information on inserting paper, the print control portion 15b may perform a setting of print processing selected with the radio buttons 63 by a user, as well as automatically performing various output settings of image data such as a setting of transmitting image data of inserting paper by facsimile, a setting of attaching image data of inserting paper to an electronic mail as a file and transmitting the image data, and the like. These processing is assumed to be performed by the processing at step S102 shown in FIG. 13. The user is thereby able to facilitate output setting operation of inserting paper.

Information of a facsimile number of a destination of facsimile transmission or an electronic mail address of a transmission destination of an electronic mail may be obtained from the address book 22d of the server apparatus 20 in which such information is registered.

The multi-function peripheral 30 then receives the above setting information, and executes various output processing such as processing to save image data of inserting paper as a file, processing to transmit image data of inserting paper by facsimile, or processing to attach image data of inserting paper as a file to an electronic mail and transmit the image data, and the like.

Note that, it may be configured that in conjunction with checking of the check box 62 by a user so as to perform printing of charging information on inserting paper, the print control portion 15b selects whether to perform processing to automatically set the radio buttons 63 to the setting for printing both of a document issued for a charged party (document for receiving side) and a document issued for a charging party (document for sending side), or to perform a setting of print processing selected from among the radio buttons 63 as well as performing various output settings of image data as described above.

For example, the client apparatus 10 stores whether either one of the above two setting processing is executed in the print setting data 14b as an initial setting, and based on the initial setting, either one of the setting processing may be executed. The user may change setting processing to be executed as appropriate by changing the initial setting.

As described above, according to the present invention, in the case of executing print processing for inserting paper that separates a first sheet on which printing is performed by a first print job and a second sheet on which printing is performed by a second print job that is executed after the first print job, print processing to generate print data including charging information of a first print job or a second print job and print generated print data on inserting paper is to be executed, thus making it possible that the inserting paper separating sheets on which printing is performed by different print jobs is not only used as merely inserting paper, but utilized effectively as a business document, so that assortment and shipment preparation of printed sheets are facilitated, while it is possible to perform clerical work such as recording of expenses promptly and precisely.

1. A printing system for executing print processing for inserting paper that separates a first sheet on which printing is performed by a first print job and a second sheet on which printing is performed by a second print job that is executed after the first print job, comprising:
a data generation portion that generates print data including charging information of the first print job or the second print job; and
a print processing portion that executes print processing for printing on the inserting paper the print data generated by the data generation portion.

2. The printing system as defined in claim 1, wherein
the print processing portion executes, after executing the first print job and before executing the second print job, the print processing multiple number of times.

3. The printing system as defined in claim 2, wherein
the print processing portion executes print processing for printing print data of a document issued for a charged party and print processing for printing print data of a document issued for a charging party.

4. The printing system as defined in claim 1, further comprising a processing execution portion that executes processing to output the print data as a file.

5. A printing method for executing print processing for inserting paper that separates a first sheet on which printing is performed by a first print job and a second sheet on which printing is performed by a second print job that is executed after the first print job, comprising:
generating print data including charging information of the first print job or the second print job; and
executing print processing for printing on the inserting paper the print data generated at the generating.
